(19) United States
(12) Patent Application Publication
(10) Pub. No.: US 2014/0223439 A1
(43) Pub. Date: Aug. 7, 2014

(54) SUPERSCALAR CONTROL FOR A PROBABILITY COMPUTER

(71) Applicant: Benjamin Vigoda, Winchester, MA (US)

(72) Inventor: Benjamin Vigoda, Winchester, MA (US)

(73) Assignee: Analog Devices, Inc., Norwood, MA (US)

(21) Appl. No.: 14/130,403

(22) PCT Filed: Feb. 22, 2011
(86) PCT No.: PCT/US2011/025753

§ 371 Date: Apr. 14, 2014

Related U.S. Application Data
(60) Provisional application No. 61/306,884, filed on Feb. 22, 2010.

(51) Int. Cl. G06F 9/48

(52) U.S. Cl. CPC G06F 9/4843
USPC 718/102

(57) ABSTRACT

A method of executing operations in parallel in a probability processing system includes providing a probability processor for executing said operations; and providing a scheduler for identifying, from said operations, those operations that can be executed in parallel. Providing the scheduler includes compiling code written in a probability programming language, that includes both modeling instructions and instructions for scheduling.

### CROSS REFERENCE TO RELATED APPLICATIONS

This application claims the benefit of U.S. Provisional Application No. 61/306,884, titled “SUPERSCALAR CONTROL FOR A PROBABILITY COMPUTER,” filed on Feb. 22, 2010. The contents of which are incorporated herein by reference

### STATEMENT AS TO FEDERALLY SPONSORED RESEARCH

This invention was made with government support under FA8750-07-C-0231 awarded by Defense Advanced Research Projects Agency (DARPA). The government has certain rights in the invention.

### FIELD OF DISCLOSURE

This disclosure relates to architecture of data processing systems, and in particular, to scheduling of computations in a data processing system.

### BACKGROUND

In the architecture of digital processors, there exist at least two approaches for achieving instruction level parallelism. One approach, referred to as the Very-Large Instruction Word (VLIW) approach, places the onus on the compiler to determine which instructions in a program can be executed in parallel. This is decided at compile time. In a second approach, a dedicated superscalar controller is placed on the chip itself. This superscalar controller decides, at run-time, which instructions can be executed in parallel.

Although the VLIW approach is still used in certain specialized applications, for general purpose processing such as Intel's or AMD's processors, the superscalar approach has become more prevalent.

Today, a significant amount of computer time is used essentially implementing Bayes formula to compute probabilities. For example, there exist on-line content distribution services that execute applications for predicting content that a consumer is likely to rate highly given content that the consumer has previously rated. Similarly, there exist retailing services that execute applications for predicting what products a consumer is likely to want to purchase given what that consumer has purchased before. Then, there exist search engines that attempt to predict what links might be relevant on the basis of search history. These applications essentially compute conditional probabilities, i.e. the probability of an event given the occurrence of prior events.

Other probabilistic applications include methods for guessing how to translate a webpage from one language to another.

In the communications area, probabilistic computation arises when embedded and mobile applications in, for example, a cell phone, predict what bits were originally transmitted based on a received noisy signal. In robotics, there exist applications for predicting the most likely optimal path across difficult terrain.

Conventional programming techniques and languages have focused on the solution of deterministic problems. While such languages and techniques can successfully solve probabilistic problems, doing so can be awkward and inefficient. In recognition of this, an academic renaissance has emerged in probability programming languages. An early example of a probability programming language is IBAL, which was created by Avi Pfeffer in 1997. Known languages include Alchemy, Bach, Blaise, Church, CILog2, CP-Logic, Csoft, DBLOG, Dyna, Factorie, Infer.NET, PyBLOG, IBAL, PMTK, PRISM, ProbLog, ProBT, R, and S+.

Recently, researchers have begun to invent electronic circuits to run probability programs more efficiently. Among the operations that such electronic circuits have been able to efficiently perform are Markov Chain Monte Carlo, and belief propagation.

### SUMMARY

In the course of probabilistic computation, there are occasionally operations that can be performed independently of other operations. By performing these operations at the same time, i.e. in parallel, one can improve performance. The difficulty that arises is identifying precisely which operations can be performed in parallel, and arranging to have the computational resources available for performing those operations. Broadly stated, this is the function of a scheduler.

In order for a scheduler to properly carry out its function, it should be able to determine which operations can be performed in parallel, and what hardware resources are available for performing those computations. Once it knows both of these, it can direct the appropriate hardware to perform the appropriate operations.

U.S. Provisional Application 61/294,740 disclosed scheduling that is determined by generating a model of a factor graph using DMPL (“Distributed Mathematical Programming Language”) and enforcing certain constraints on the mapping of nodes in the graph to hardware elements on a chip. This ties the predetermined schedule to a particular hardware configuration. If the hardware configuration were changed, the schedule would no longer apply.

The foregoing application assumes a particular set of operations to be executed on a system with a fixed hardware configuration.

In some cases, the schedule can be changed to different sequences of concurrent operations. For instance, a sequence of concurrent operations may be stored in a data table used by a sequencer, as is similar to the case in which a VLIW processor uses a series of instructions in which each instruction encodes multiple operations to be concurrently performed by multiple functional units. In such cases, the scheduler would generate a schedule ahead of time for executing instructions in parallel on the particular hardware configuration. However, the schedule would still be tied to that particular hardware configuration.

A further approach is based on the recognition that in a probabilistic processing system, one can dynamically schedule parallel execution of operations. A scheduler according to the invention can thus determine what hardware is available for executing the various processing operations and, on-the-fly, create a suitable schedule for carrying out operations in parallel. For example, the scheduler may be driven by a data table that identifies a sequence of operations to be performed, in which case the scheduler controls concurrent execution of operations using the available hardware.

In one aspect, the invention features a method of executing operations in parallel in a probability processing system includes providing a probability processor for executing said operations; and providing a scheduler for identifying, from said operations, those operations that can be executed in parallel. Providing the scheduler includes compiling code written in a probability programming language, that includes both modeling instructions and instructions for scheduling.

Practices of the method include those in which providing the scheduler includes providing a scheduler that imposes an order in the operations, those in which providing the scheduler includes providing a scheduler that chooses between one of a plurality of scheduling methods, those in which providing the scheduler includes providing a scheduler that randomly chooses a scheduling method from a set of scheduling methods, those in which providing the scheduler includes providing a scheduler that randomly selects an edge in a factor graph and randomly selects a direction associated with the edge, and those in which providing the scheduler includes providing a scheduler that randomly selects a node in a factor graph and updates messages on an edge incident on the node.

In another aspect, the invention features an article of manufacture that includes a computer-readable medium having encoded thereon software for executing any combination of the foregoing methods.

In yet another aspect, the invention features a data processing system configured to execute software for carrying out any combination of the foregoing methods.

These and other features of the invention will be apparent from the following detailed description and the accompanying drawings, in which:

### DESCRIPTION OF THE DRAWINGS

FIG. 1 shows a chain graph;

FIG. 2 shows instantiation of a chain graph;

FIG. 3 shows a grid graph; and

FIG. 4 shows instantiation of a grid graph having a via for enabling a message to control fabric interconnect.

### DETAILED DESCRIPTION

One way to carry out probabilistic computations is to implement a factor graph model in which constraint nodes and function nodes exchange messages. In general, the factor graph begins operation at some state, then relaxes in the course of multiple iterations into a second state, which represents a solution.

In an effort to more rapidly relax the factor graph, it is useful to schedule message transmission. One way to schedule message transmission, which is referred to as “residual belief propagation,” is to inspect the last two times that a particular message was sent. If the message changed considerably between those two times, that message is prioritized for update on the next message passing iteration. Messages that are not changing are generally not transmitted as frequently since their priority is low. In this method, one saves time by preferentially transmitting only those messages that have changed significantly.

Another scheduling method, which can be viewed as a variant of residual belief propagation, is the “residual splash” method. In the residual splash method, a “splash” of a given node is a set of nodes forming a sub-graph. This sub-graph defines a tree having that node as its root. The residual splash scheduling method sorts splashes by their residuals and updates the nodes of those splashes having the largest residuals.

During their execution, probability programs often consume significant computational resources. Probability programs are frequently executed on standard desktop computers or clusters of standard x86 processors. These standard platforms were intended to execute deterministic programs. As a result, their computational resources often fall short of what is required. This tends to limit the size and complexity of probability programs that can be run on existing hardware platforms.

An alternative to the standard processor architectures discussed above is a probability processor. A probability processor would efficiently run probability programs using dedicated hardware. Although a probability processor might not necessarily be Turing complete, and although such a processor may not be optimized for performing computations for applications such as Microsoft Word, such a processor would be as much as three orders of magnitude faster than conventional processors for executing probability programs.

Such a probability processor executes in combination with a scheduler. The relationship of this scheduler to the probability processor is similar to the relationship between a superscalar controller and a conventional processor. Both are intended to identify operations that can be executed in parallel, in an effort to more efficiently use available hardware.

One function of the scheduler is to impose an order on computations in the graphical or generative model. Another function of the scheduler is to decide which messages should be processed and which should be discarded. This is particularly important when the a probability program defines a huge or even infinitely large probabilistic graphical model, and the probability processor has only a limited capacity for performing the probabilistic message passing or variable sampling computations required by this graph.

In one embodiment, the scheduler is a hardware implementation of a pre-selected scheduling method. For example, one such scheduler is a hardware implementation of the residual splash method described above.

Since different schedules makes sense for different probabilistic graphical models, a scheduler could ideally be able to run a range of scheduling methods efficiently. For example, although the residual splash method is one method for scheduling message transmission, it is not ideal under all circumstances. Thus, in one embodiment, the scheduler is a more general computational machine that is not wedded to a particular choice of scheduling method.

To implement a scheduler that selectively chooses different scheduling methods, it is useful for the probability programming language to permit one to define both the schedule and the inference model using the language. In one implementation, the programmer writes the scheduling method as part of the probability program itself, or includes a DMPL (“Distributed Mathematical Programming Language”) library that provides the scheduling method. DMPL is described in more detail in U.S. Provisional Application 61/294,740, filed Jan. 13, 2010, and entitled “Implementation of Factor Graph Circuitry.”

Advantages of including the schedule within the probability program are numerous. For example, when the schedule is included within the probability program, it becomes unnecessary to hard-wire a particular choice of scheduling method into the probability processor. This enables the scheduling method to be replaced by a better method, should one be invented for a particular kind of graph. Another advantage of including the schedule within the probability program is that the programmer has more much control over the schedule. This allows the programmer to increase the speed of convergence as the probability program runs. Yet another advantage is that the programmer need not know about scheduling at all, but can instead simply invoke a scheduler method from a library. This makes writing a probability program faster and easier. Finally, the ability to incorporate scheduling methods into the probability programming itself enhances collaboration within the developer community, since scheduling methods would then be as easily shared among developers as probability programs.

The scheduling method is “compiled” from DMPL into a scheduler for the probability processor. Once compiled, the scheduler sends control messages that cause sequencing of message computations in the probabilistic graphical model that is being implemented on the probability processor.

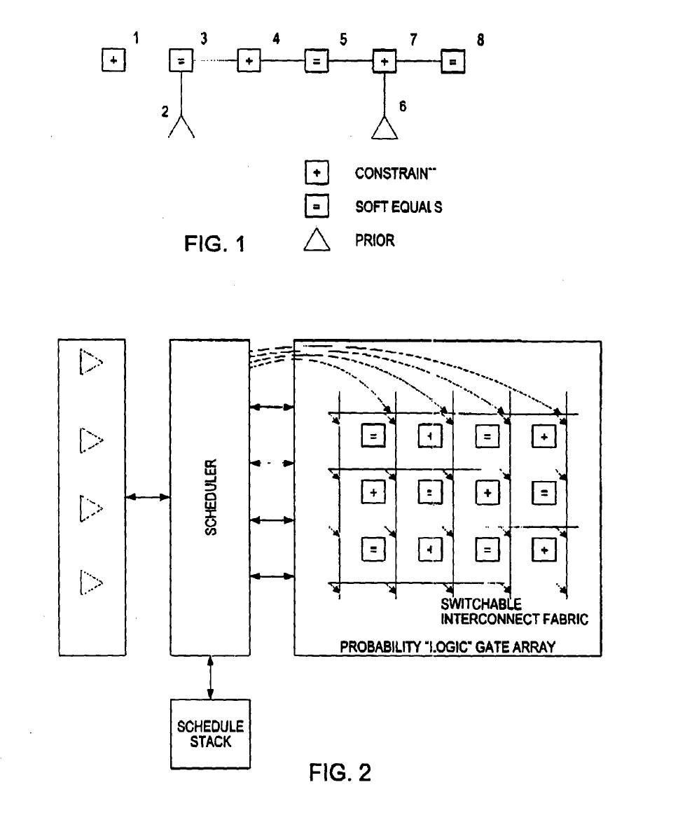

In one embodiment, which is useful for scheduling a chain graph. A typical chain graph includes a linear chain of variable nodes alternating with constraint nodes, as shown in FIG. 1. The variable nodes in the illustrated chain graphs are implemented as soft-equals gates. Certain ones of the variable nodes are connected to memory elements. In such cases, selection of that node triggers a memory access to that memory element.

The scheduler selects a message for computation. If necessary, the necessary hardware is instantiated, as shown in FIG. 2.

For chain graphs, the scheduler is a ring counter that indexes through a list of nodes in the graph. The list orders the nodes from left to right in the graph. When a node is selected for computation, its inbound messages are fetched from memory and input into a circuit element. The circuit element then uses these inbound messages in computing the outgoing messages for that node.

In another embodiment, each node in the graph is pre-mapped to a particular computational element in the hardware. As a result, when that node is selected for updating, the scheduler knows which hardware element should compute the update. This method is described in more detail in a U.S. Application 61/294,740, entitled

“Implementation of Factor Graph Circuitry”, and filed on Jan. 13, 2010, the contents of which are herein incorporated by reference. In this embodiment, a checker confirms at compile-time that a proposed schedule will not cause a single hardware element to be used for two different computations at the same time.

In another embodiment, nodes in the graph are mapped to circuit elements at run-time. One way to do this is for the scheduler to keep a memory stack of available hardware elements that are available for computation. When a hardware element is in use, its index comes off the stack. When it becomes available for computation, its index is pushed back onto the stack. Whenever the scheduler needs a computational element to compute a graph node, it assigns whatever hardware element is on top of the stack to carry out the computation.

In yet another embodiment of a scheduler, a bit mask includes a bit assigned to each computing element. The state of the bit indicates whether that computing element is free or busy. The scheduler selects a hardware computing element whether or not it is free. A collision checker then inspects the mask and determines whether the selected computing element is free. If the computing element turns out to be busy, the collision checker generates an error, and the scheduler tries again with another computing element.

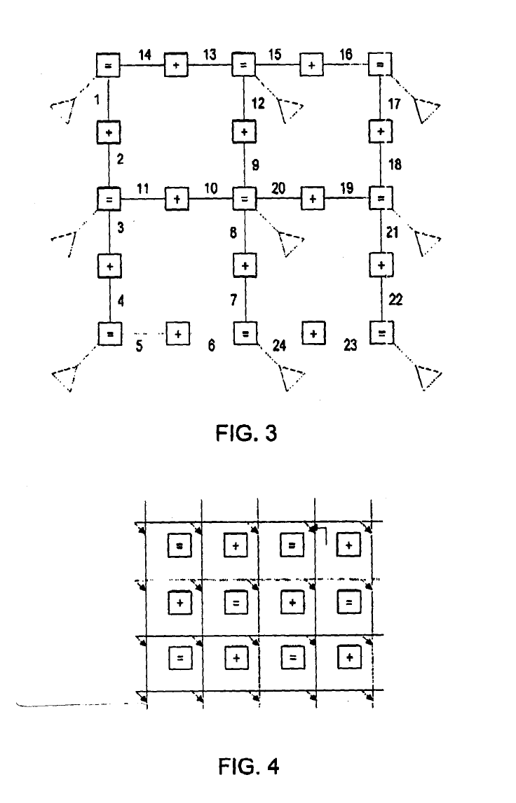

In some cases, the nodes in a graph to be implemented define a grid, as shown in FIG. 3. Such a graph includes variable nodes, denoted with an “=”, and constraint nodes, denoted by a “+,” and edges joining variable nodes and constraint nodes.

Another embodiment of a scheduler provides scheduling for scheduling a complicated loopy graph with fixed structure, such as that used for low-density parity check (LDPC) error correction decoding. Such a scheduler is described in U.S. provisional applications 61/156,792, filed Mar. 2, 2009, and 61/293,999, filed on Jan. 10, 2010, both of which are entitled “Belief Propagation Processor,” and the contents of which are both herein incorporated by reference. Compilation for such a scheduler into hardware, and checking the resulting hardware for collisions is described in U.S. Application 61/294,740.

In one embodiment, the scheduling method is itself a random method and is therefore appropriately expressed by a probability program. One such scheduling method includes randomly selecting an edge in the model and randomly selecting a direction on that edge. This is followed by updating the message on the randomly selected edge that is directed in the randomly selected direction. As a result, each message is as likely to be chosen as any other message. In essence, this results in a uniform probability distribution over all messages in the model.

Another randomized scheduling method is one that randomly selects a constraint node in a factor graph, and then updates messages on all edges incident on that constraint node. Similarly, another randomized scheduling method randomly selects a variable node, such as an equals gate, from the factor graph, and updates all edges incident on that variable node. Yet another randomized scheduling method includes randomly selecting variable nodes, and updating the corresponding variables by Gibbs sampling,

Another example of a randomized scheduling method is a randomized residual belief propagation method. In this method, residuals, which correspond to changes in messages and beliefs, are normalized to form a probability distribution. Then, an object, which can be a node, edge, or message, is chosen at random from this distribution. This assures that, on average, the objects with the highest residuals will be updated more often. However, it also assures that objects with smaller residuals will occasionally be updated.

A second example of a randomized scheduling method is a randomized residual splash method. In this method, residuals of splashes are normalized to form a probability distribution. Then a splash is randomly chosen at random from this distribution, and all objects in the splash are updated. This assures that, on average, objects with the highest residuals will be updated more often. However, it also assures that objects with smaller residuals will occasionally be updated.

A third example of a randomized scheduling method is a randomized likelihood magnitude belief propagation method. In this scheduling method, magnitudes of the likelihoods of the messages in the model from the most recent iteration are normalized to form a probability distribution. In the next iteration, an object (node, edge, message, or splash) is chosen at random from this distribution. This assures that, on average, objects with the largest likelihood magnitudes (greatest certainty) will be updated more often. It also ensures that objects with smaller likelihood magnitudes will occasionally be chosen.

A fourth example of a randomized scheduling method is a randomized likelihood belief propagation method. In this scheduling method, likelihoods of the messages from the most recent iteration are normalized to form a probability distribution. In the next iteration, an object (node, edge, message, or splash) is chosen at random from this distribution, and updated. This ensures that, on average, objects with the largest likelihoods (greatest certainty) will be chosen for update more often. However, it also ensures that objects with smaller likelihood magnitudes will occasionally be chosen.

In variants of each of the foregoing methods, the distribution is sampled without being normalized.

Variants of the third and fourth examples also include randomized small likelihood magnitude scheduling methods, in which the probability of an object being chosen is inversely related to its likelihood or likelihood magnitude. This causes less certain objects to be scheduled for update more frequently.

In one embodiment, the probability processor is a programmable array stochastic message-passing gates (for Markov Chain Monte Carlo or Gibbs Sampling), and the scheduler method is a stochastic method that “samples” a schedule from a probability distribution that is pre-defined or inferred while the program runs. As a result, the scheduling method is itself a probability program.

In the case where the scheduler method is a stochastic method, the scheduler's probability distribution over messages defines the probability that any given message in the graph will be computed. If the distribution is uniform then the schedule will be completely random. However, if the distribution assigns greater probability to certain messages, then the scheduler would be more likely to select those messages for computation.

In some cases, although some concurrent operations are easy to identify, it is difficult to identify all concurrent operations that are possible in a sequence of operations. For such cases, it is useful to identify the most difficult-to-find concurrent operations at compile time and to identify the remaining concurrent operations at run time.

In another embodiment, the scheduler is a general purpose Turing Machine that runs the scheduling method and controls the message computation machinery.

In yet another embodiment, the scheduler includes stochastic logic that runs the scheduling method and controls the message computation machinery. The stochastic logic is implemented in analog logic, digital soft-gates, a general-purpose Turing machine, or any other kind of computing hardware.

Having described the invention, and a preferred embodiment thereof, what is claimed as new and secured by letters patent is:

1. A method of executing operations in parallel in a probability processing system, said method comprising
providing a probability processor for executing said operations; and
providing a scheduler for identifying, from said operations, those operations that can be executed in parallel;
wherein providing said scheduler comprises compiling code written in a probability programming language, said code including modeling instructions and instructions for scheduling.

2. The method of claim 1, wherein providing said scheduler comprises providing a scheduler that imposes an order in said operations.

3. The method of claim 1, wherein providing said scheduler comprises providing a scheduler that chooses between one of a plurality of scheduling methods.

4. The method of claim 1, wherein providing said scheduler comprises providing a scheduler that randomly chooses a scheduling method from a set of scheduling methods.

5. The method of claim 1, wherein providing said scheduler comprises providing a scheduler that randomly selects an edge in a factor graph and randomly selects a direction associated with said edge.

6. The method of claim 1, wherein providing said scheduler comprises providing a scheduler that randomly selects a node in a factor graph and updates messages on an edge incident on said node.

7. (canceled)

8. A nontransitory computer-readable medium having encoded thereon software comprising instructions for
providing a probability processor for executing said operations; and
providing a scheduler for identifying, from said operations, those operations that can be executed in parallel;
wherein providing said scheduler comprises compiling code written in a probability programming language, said code including modeling instructions and instructions for scheduling.

9. A data processing system configured to execute software for
providing a probability processor for executing said operations; and
providing a scheduler for identifying, from said operations, those operations that can be executed in parallel;
wherein providing said scheduler comprises compiling code written in a probability programming language, said code including modeling instructions and instructions for scheduling.
